(19) United States
(12) Patent Application Publication
(10) Pub. No.: US 2010/0167796 A1
(43) Pub. Date: Jul. 1, 2010

(54) ELECTRONIC DEVICE

(75) Inventors: YUNG-HUNG CHU, Tu-Cheng (TW); WEN-YAN YANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/645,422

(22) Filed: Dec. 22, 2009

(30) Foreign Application Priority Data
Dec. 29, 2008 (CN) 200810306627.4

(51) Int. Cl. H04M 1/03; H04M 1/00

(52) U.S. Cl. 455/569.1; 455/575.2

(57) ABSTRACT

An electronic device includes a main body, an earphone partitioning structure, and a cover. The main body defines an earphone housing to removably receive an earphone. The earphone partitioning structure is disposed in the earphone housing and includes a first limiting wall and a second limiting wall. The first and the second limiting walls are configured to restrict movement of the earphone. The cover is detachably coupled with the main body for covering and uncovering the earphone housing.

### BACKGROUND

1. Technical Field

The present disclosure relates to electronic devices, and particularly to an electronic device capable of communicating with a wireless earphone.

2. Description of Related Art

Mobile phones have become an indispensable tool for people in daily life. Mobile phones include hands-operated type mobile phones and hands-free type mobile phones. The hands-operated type mobile phones need the users to hold the phone when making phone calls, this is an inconvenience. The hands-free type mobile phones are capable of communicating using wired or wireless earphone, this is convenient.

However, wireless earphones are easily misplaced or lost.

Thereof, an improved electronic device is desired.

### BRIEF DESCRIPTION OF THE DRAWINGS

Many aspects of the embodiments can be better understood with reference to the following drawing. The components in the drawing are not necessarily drawn to scale, the emphasis instead being placed upon clearly illustrating the principles of the present embodiments.

FIG. 1 is an exploded view of an electronic device receiving an earphone in accordance with an embodiment, where the electronic device includes a cover and an earphone.

FIG. 2 is a perspective view of the electronic device of FIG. 1 with the cover being removed.

FIG. 3 is a perspective view of the earphone of FIG. 1.

### DETAILED DESCRIPTION

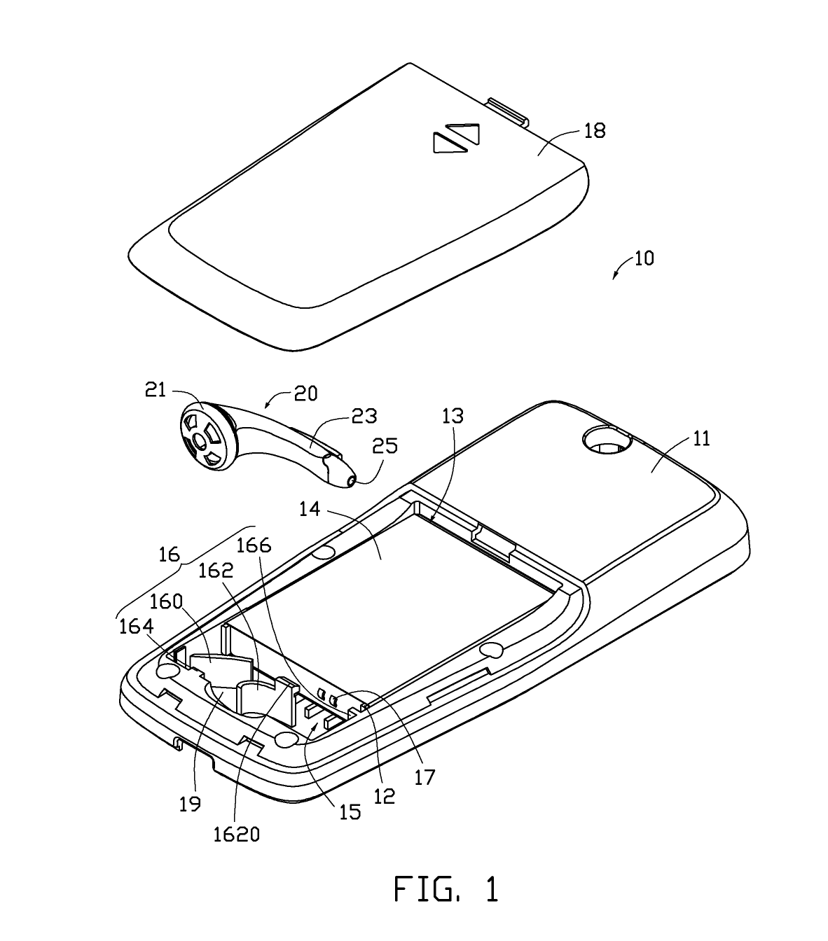

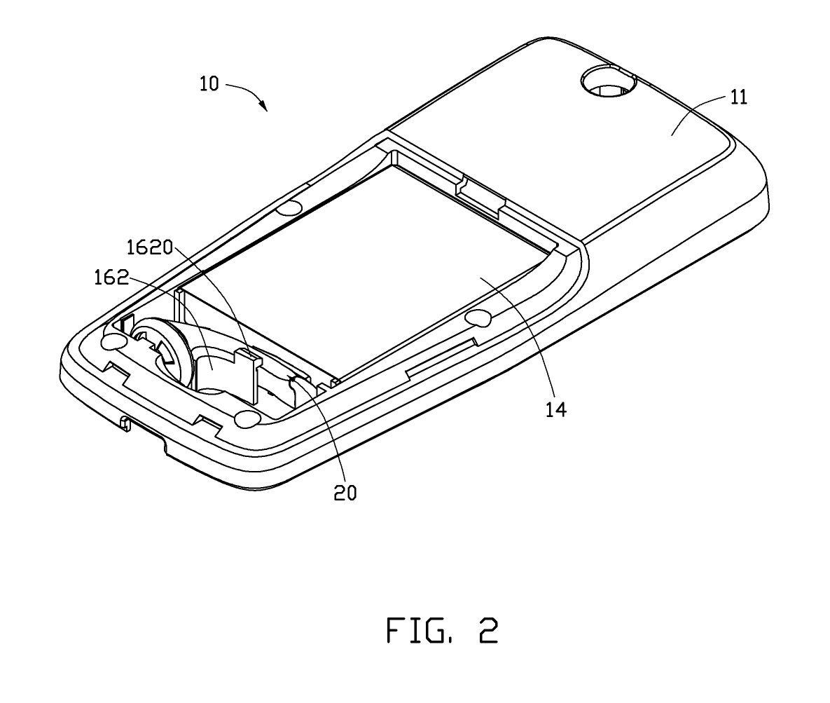

Referring to FIGS. 1 and 2, an electronic device 10 includes a main body 11, and a cover 18 in accordance with an embodiment. The electronic device 10 is operable to wirelessly communicate with an earphone 20. In the embodiment, the electronic device 10 is a mobile phone. The earphone 20 may be a wireless earphone, such as a Bluetooth® earphone or an infrared earphone.

The main body 11 defines a battery housing 13 and an earphone housing 15. The cover 18 is detachably coupled with the main body 11 for covering and uncovering the battery housing 13 and the earphone housing 15. The battery housing 13 is configured to removably receive a battery 14. The earphone housing 15 is configured to removably receive the earphone 20 for integrating the earphone 20 with the main body 11.

The battery housing 13 and the earphone housing 15 are recesses formed on an outer surface of the main body 11. The battery housing 13 and the earphone housing 15 communicate with each other. Two limiting members 12 are placed on a boundary between the battery housing 13 and the earphone housing 15. The limiting members 12 are on opposite sides of the battery housing 13 correspondingly. The limiting members 12 are rectangle and configured to confine the battery 14 in the batter housing 13 and prevent the battery 14 from sliding into the earphone housing 15. An earphone partitioning structure 16 is configured in the earphone housing 15 for securing the earphone 20 in the earphone housing 15.

The earphone partitioning structure 16 includes a first limiting wall 160, a second limiting wall 162, a first ledge 164, and a second ledge 166. A receiving space 19 is bounded by the limiting wall 160, the second limiting wall 162, the first ledge 164, and the second ledge 166. The receiving space 19 matches the shape of earphone 20.

The first and second limiting walls 160, 162 extend from a bottom surface of the earphone housing 15. The limiting wall 160 is a sheet matching a side of the transducer 21 of the earphone 20. The second limiting wall 162 is a curved sheet matching the earbud stalk 23 of the earphone 20. An end of the second limiting wall 162 faces the first limiting wall 160. The space between the first and the second limiting walls 160, 162 is configured for receiving the earbud stalk 23 of the earphone 20. A catch 1620 extends perpendicularly from the top of the second limiting wall 162 towards the battery housing 13.

The first ledge 164 is a rectangle sheet protruding from a side surface of the earphone housing 15 towards the battery housing 13. The first ledge 164 is adjacent to the first limiting wall 160. The second ledge 166 is rectangle sheet protruding from another side surface of the earphone housing 15. The second ledge 166 is adjacent to the limiting member 12 and away from the first limiting wall 160.

To place the earphone 20 in the earphone housing 15, the earphone 20 is inserted between the first limiting wall 160 and the second limiting wall 162. The first limiting wall 160 and the second limiting wall 162 tightly clamp/grasp opposite sides of the transducer 21 of the earphone 20, the catch 1620 catches the earphone 20, and the first ledge 164 and the second ledge 166 restrict against the two opposite ends of the earphone, such as the transducer 21 and the tail 25 the earphone 20. As a result, the earphone 20 is restricted from any movement with respect to the electronic device 10 by the earphone partitioning structure 16. Thus, the earphone 20 is stably fixed in the earphone housing 15.

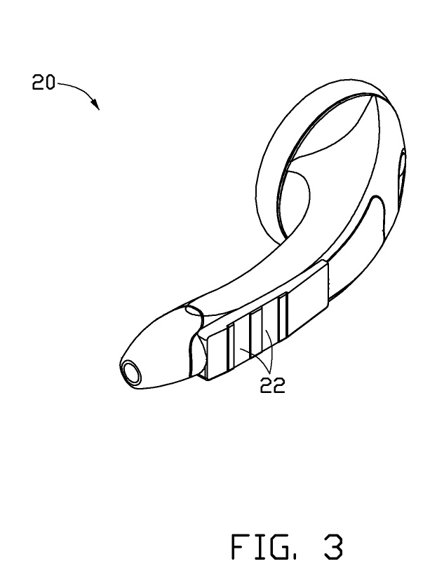

Referring to FIG. 3, the earphone 20 defines two grooves in the outer surface of the earbud stalk 23. Two first conductive contacts 22 are fixed in the two grooves accordingly. The electronic device 10 further includes two second conductive contacts 17 corresponding to the two first conductive contacts 22. The two second conductive contacts 17 are electrically connected to the battery 14. In this embodiment, the two first conductive contacts face the battery housing 13 when the earphone 20 is received in the earphone housing 15. The two second conductive contacts 17 are formed on the battery 14 and face the earphone housing 15. When the battery 14 is received in the battery housing 13, the two first conductive contacts 22 contact the two second contacts 17, and the earphone 20 is charged by the battery 14. In another embodiment, the two second conductive contacts 17 can be formed on the main body 11, and are electrically connected to the electrodes of the battery 14 when the battery is received in the battery housing 13.

As described above, the electronic device 10 can integrate the earphone 20 in the main body 11. As a result, the electronic device 10 is capable of preventing the earphone 20 from being misplaced or loss. Further, the electronic device 10 is capable of charging the earphone 20 via the battery 14 so no need to recharge the earphone 20 separately, this is convenient.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An electronic device for integrating an earphone therewith, the electronic device comprising:
a main body defining an earphone housing to removably receive the earphone, the main body comprising an earphone partitioning structure disposed in the earphone housing, the earphone partitioning structure comprising a first limiting wall and a second limiting wall, the first and the second limiting walls configured to restrict movement of the earphone; and
a cover detachably coupled with the main body for covering and uncovering the earphone housing.

2. The electronic device of claim 1, wherein the first limiting wall and the second limiting wall adjacently extend from a bottom surface of the earphone housing, the first limiting wall and the second limiting wall are separately configured to form a space to match a shape of the earphone.

3. The electronic device of claim 2, wherein an end of the second limiting wall faces the first limiting wall.

4. The electronic device of claim 2, wherein the second limiting wall comprises a catch, the catch extends perpendicularly from the top of the second limiting wall towards the battery housing.

5. The electronic device of claim 1, further comprising a battery, the battery is removably received in a battery housing defined in the main body, when the earphone is disposed in the earphone housing, the earphone is electrically connected to the battery for being charged thereof.

6. The electronic device of claim 5, wherein the battery is formed with two conductive contacts for electrically connecting the earphone to the battery.

7. The electronic device of claim 5, wherein the main body is further formed with two conductive contacts for electrically connecting the earphone to the battery.

8. The electronic device of claim 1, wherein the earphone partitioning structure further comprises a first ledge and a second ledge, the first ledge protrudes from a side surface of the earphone housing and adjacent to the first limiting wall, the second ledge protrudes from another side surface of the earphone housing, the second ledge adjacent to the limiting member and away from the first limiting wall, the first and the second ledges restrict against a transducer and a tail of the earphone accordingly when the earphone is received in the earphone housing.

9. An electronic device, comprising:
a main body defining a battery housing for removably receiving a battery, and an earphone housing for removably receiving an earphone; and
an earphone partitioning structure disposed in the earphone housing, the earphone partitioning structure comprising a first limiting wall and a second limiting wall, the first and the second limiting walls restricting against two opposite sides of the earphone, the second limiting wall comprising a catch for preventing the earphone from being removed from the earphone housing without an applying force.

10. The electronic device of claim 9, wherein the first and the second limiting walls adjacently extend from a bottom surface of the earphone housing and defines a space that match with a shape of earphone.

11. The electronic device of claim 10, wherein an end of the second limiting wall faces the first limiting wall.

12. The electronic device of claim 9, wherein the catch extends perpendicularly from the top of the second limiting wall towards the battery housing.

13. The electronic device of claim 9, further comprising two conductive contacts, the two conductive contacts are electrically connected to the battery, the two conductive contacts are electrically connected to the earphone for charging the earphone when the earphone is received in the earphone housing.

14. The electronic device of claim 13, wherein the two conductive contacts are formed on the battery.

15. The electronic device of claim 13, wherein the two conductive contacts are formed on the main body.

16. The electronic device of claim 9, wherein the earphone partitioning structure further comprises a first ledge and a second ledge, the first ledge protrudes from a side surface of the earphone housing and adjacent to the first limiting wall, the second ledge protrudes from another side surface of the earphone housing, the second ledge adjacent to the limiting member and away from the first limiting wall, the first and the second ledges restrict against a transducer and a tail of the earphone accordingly when the earphone is received in the earphone housing.

17. An electronic device, comprising:
a main body receiving a battery, the main body defining an earphone housing;
an earphone communicating with the main body, the earphone removably received in the earphone housing;
an earphone partitioning structure disposed in the earphone housing, the earphone partitioning structure comprising a first limiting wall and a second limiting wall, the first and the second limiting wall configured to restrict against two opposite sides of the earphone, the second member comprising a catch, the catch preventing the earphone from being removed from the earphone housing without an applying force.

18. The electronic device of claim 17, further comprising a cover detachably coupled with the main body for covering and uncovering the earphone housing.

19. The electronic device of claim 17, wherein the earphone is a wireless earphone.

20. The electronic device of claim 19, further comprising at least one first conductive contact and at least one second conductive contact, the at least one first conductive contact is formed on the earphone, the at least one second conductive contact is selectively formed on one of the main body and the battery and electrically connected to the battery, the at least one second conductive contact attaches to the at first conductive contact for charging the earphone when the earphone is received in the earphone housing.
